(19) United States
(12) Patent Application Publication
(10) Pub. No.: US 2022/0284357 A1
(43) Pub. Date: Sep. 8, 2022

(54) SYSTEMS AND METHODS TO BOOK STAGES

(71) Applicants: James Richard BRAY, Rogers, AR (US); Thomas Roy BRAY, Houston, TX (US)

(72) Inventors: James Richard BRAY, Rogers, AR (US); Thomas Roy BRAY, Houston, TX (US)

(21) Appl. No.: 17/641,387

(22) PCT Filed: Sep. 11, 2020
(86) PCT No.: PCT/US2020/050504

§ 371 Date: Mar. 8, 2022

Related U.S. Application Data
(60) Provisional application No. 62/898,984, filed on Sep. 11, 2019.

(51) Int. Cl. G06Q 10/02

(52) U.S. Cl. CPC G06Q 10/02

(57) ABSTRACT

Computer-implemented systems and methods for automating the availability and booking of multiple entertainment venues accessible to artists, venues, and others who independently need to view, reserve, and utilize performance areas throughout a regional or nationwide market.

### CROSS-REFERENCE TO RELATED APPLICATIONS

This application claims priority to U.S. Provisional Patent Application Ser. No. 62/898,984, filed Sep. 11, 2019, entitled “System and Method to Book Stages,” which is incorporated herein by reference.

### FIELD

The present disclosure generally relates to systems and methods to book stages, particularly computer implemented systems and methods for venues and artists to coordinate event bookings.

### BACKGROUND

Artists want to perform in front of live audiences, and many would do so for tips (gratuities) alone. However, finding venues where artists can perform is difficult since the current supply of stage hours actually being used for live events at venues is very limited, and the effort required to gain approval from the venue to secure a stage booking is both time consuming and difficult.

Venue owners and managers recognize the benefits of having live music and other live events, and they would like to have it more often, but they find it difficult and time consuming to locate, evaluate, manage and budget the booking of artists suitable for their establishment. Therefore, venue stages largely go unused during open venue hours. When used, it is typically for just two to three peak business hours (usually at night), or just one, two or three days (usually Thursday, Friday, and/or Saturday), and typically only known artists are booked.

There are other Internet and mobile apps software designed to facilitate the artist booking process for venues. However, the others simply computerize the age-old manual booking processes, a system that puts the burden on the venue owners, managers, or booking agents to find and book artists by negotiating terms for the same limited stage times. They do not expand the available stage inventory. With the other systems and methods, artists may be able to post their digital portfolio in the software or mobile app, but it is still up to venues to find the portfolio and contact the artist. When artists desire to actively pursue a stage booking at particular venues, they compete with many other artists for a very limited supply of stage opportunities, and artists must work the phone, leave messages, email, text (i.e., constantly contact), and send their digital portfolio to venue owners and managers for evaluation to be considered for a booking. Venue owners and managers are often too busy to return voice messages, texts and emails, and may not ever get around to evaluating and booking a new and unfamiliar artist.

The process can be exhausting for artists, so many give up on their dreams and stop pursuing a career in the performing arts and entertainment.

The present disclosure aims to address some of these issues by creating a digital marketplace where venues offer available time slots and artists may initiate the stage bookings. By reversing and redefining the age-old manual methods and computerized versions of those manual methods, the present disclosure can result in an expansion in the number of stage hours made available by venues for artists; consequently, there are more opportunities available for artists and those that aspire to become artists to gain experience and improve their craft, showcase their talents to audiences, which ultimately provides a structure and method that builds a more vibrant live music, live performing arts, and live entertainment scene in communities everywhere.

These and other benefits may be readily understood and appreciated using this disclosure and the drawings and claims described herein.

### SUMMARY

Computer assisted systems and methods for automatically creating, maintaining, and accessing an interactive database for venues and artists embodied in a non-transitory computer readable medium are described herein. Generally, a non-transitory computer readable medium having stored software instructions that, when executed by a processor, cause the processor to automatically create, maintain, and access an interactive database for booking stages, by executing the steps of receiving venue data input from a venue; storing the venue data input in a non-transitory computer storage medium; causing venue data input to be viewable to target artists designated by the venue through a graphical user interface; receiving artist data input from an artist; storing the artist data input in a non-transitory computer storage medium; generating a booking request from the artist data input; and, causing the booking request to be viewable and actionable to the venue through a graphical user interface.

One or more embodiments may include the method of any preceding paragraph further including the steps of creating a booking response when the venue submits an acceptance of the booking request, the booking response stimulating the processor the execute the steps of alerting the artist to the acceptance; removing the first set of data input from the graphical user interface of the target artists.

One or more embodiments may include the method of any preceding paragraph, further comprising publishing notice of an event to a community.

One or more embodiments may include the method of any preceding paragraph, wherein the first set of venue data input is information concerning the available stages and time slots at the venue.

One or more embodiments may include the method of any preceding paragraph, wherein the artist data input is a selection of a stage at an available time slot.

One or more embodiments may include the method of any preceding paragraph, wherein the target artists are of a group selected by the venue based on desired criteria.

One or more embodiments may include the method of any preceding paragraph, wherein the booking request includes recordings of the target artist capable of being transmitted to and viewed by the venue.

A computer implemented system for facilitating artist access to a set of available venues and time slots is described generally herein. The system has an interactive database that adapts and automatically adjusts to input from a plurality of users, the interactive database having memory capable of storing a plurality of instructions and at least one processor cooperatively connected to the memory and capable of executing the plurality of instructions; and at least one device capable of displaying a graphical user interface and receiving a plurality of instructions.

One or more embodiments may include the system of any preceding paragraph, wherein the plurality of users comprise at least one venue and at least one artist.

One or more embodiments may include the system of any preceding paragraph, wherein the plurality of users comprise at least one venue, at least one artist, and a community.

One or more embodiments may include the system of any preceding paragraph, wherein the plurality of instructions are venue data input conveying available stages and time slots; and, artist data input conveying an artist's interest in booking an available stage and time slot.

One or more embodiments may include the system of any preceding paragraph, wherein the plurality of instructions further comprises a response to a booking request.

### BRIEF DESCRIPTION OF DRAWINGS

FIG. 1 illustrates an example screenshot of a venue interface where venues may communicate their stage availability.

FIG. 2 illustrates an example screenshot of an artist interface where artists may view and select available stages based on certain criteria.

FIG. 3 illustrates an example screenshot of a booking request from an artist's perspective.

FIG. 4 illustrates an example screenshot of a booking request from a venue's perspective.

FIG. 5 illustrates a flowchart of example venue data input.

FIG. 6 illustrates a flowchart of example artist data input.

FIG. 7 illustrates a high-level block diagram of the environment and software architecture for the system.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Unless otherwise specified, all compounds described herein may be substituted or unsubstituted and the listing of compounds includes derivatives thereof.

The term “user” should be understood by those of ordinary skill in the art to include any person or entity that may benefit from the use of this system. This can include but is not limited to artists, agents, talent booking agents, music promoters, club promoters, venue owners, venue managers, stage managers, event coordinators, community users, and members of the public interested in live performances.

The term “artists” should be understood by those of ordinary skill in the art to include those that have a skill or talent to showcase. This includes, but is not limited to, performing artists, entertainers, musicians, DJs, comedians, magicians, actors, poets, performers, thespians, and clowns.

The term “venue” should be understood by those of ordinary skill in the art to include any facility at which a stage is available, including but not limited to, restaurants, bars, cafes, breweries, wineries, coffee houses, private or public event spaces, private or public clubs, festival locations, wedding and reception locations, opry houses, listening rooms, parks, arenas, fairgrounds, music or performing arts theaters and centers, galleries, and busking locations.

The term “stage” should be understood by those of ordinary skill in the art to include any space where artists can perform.

The present disclosure expands the available stage opportunities for artists by viewing every open venue hour as stage inventory, giving venue users an easy way to define their stage inventory and list it in a stage, venue and artist marketplace, and targeting preferred artist types.

The present disclosure makes it easier for artists to initiate the booking process, by creating an available stage marketplace for the artists to view. It makes it easier for venues, and reduces the venue's risks by giving venues a way to book artists for unused stages by listing their stage inventory in a stage, venue and artist marketplace at desired payment terms, allowing artists willing to play at the stage for the terms offered to discover and initiate the booking, and allowing the venues to easily evaluate the artist before either declining or accepting the booking.

The present disclosure creates more opportunities for artists, and those that aspire to become one, both young and old, to play in front of live audiences, gain experience and improve their craft; it ultimately provides a structure and method that builds a more vibrant live music, live performing arts, and live entertainment scene in communities everywhere.

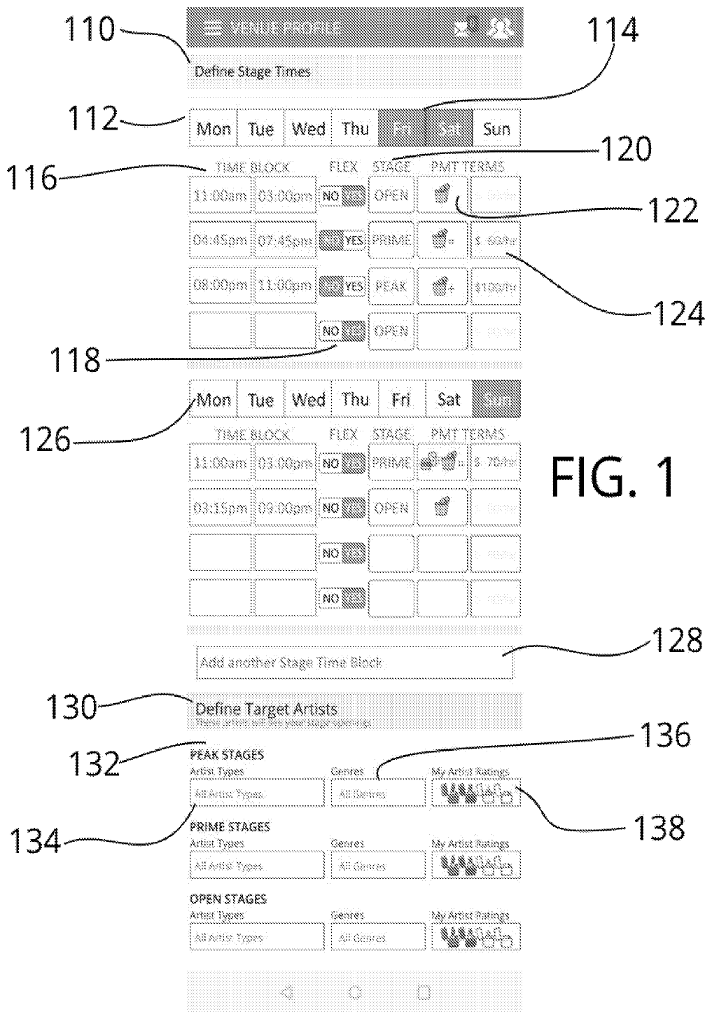

FIG. 1 illustrates an example screenshot of a venue interface where venues may communicate their stage availability. The venue is prompted to Define Stage Times 110, and the venue may define specific days and time blocks that the venue will be listing in the available stage, venue and artist marketplace for artists to discover and request bookings. The day-of-week selection 112 toggles between unselected and selected depending on input from the venue. In this example, the venue has defined Friday and Saturday as available days 114.

The TIME BLOCK 116 allows the venue to define multiple blocks of times for the available days 114. Each defined time block 116 is considered an available stage until it is either booked by an artist or overridden as a closed stage by the venue. Once a stage is booked or closed, it is no longer displayed to target artists to select.

The FLEX 118 determines if an artist must book and perform for the entire time block, or if they may request a booking to perform for only a portion of the time block. The STAGE 120 is a set of stage categories defined by the venue in which the venue may select desired artist types 134, genres 136, and/or a minimum level of artist ratings 138 it desires for a specific time block 116. The example shows stage categories 120 of PEAK, PRIME and OPEN. In certain other embodiments, further stage categories 120 may be present beyond PEAK, PRIME, and OPEN, depending on the type of venue and the desired entertainment or artists.

The PMT TERMS 122 and 124 are the payment terms selected and defined by the venue. In FIG. 1, a tip bucket icon 122 indicates the artist that selects this stage and time block will be compensated only by tips. For certain other available time slots, a venue may enter a compensation rate 124 to indicate the artist may be compensated with a minimum average hourly wage guaranteed by the venue. In certain embodiments, tip bucket icon 122 or the defined compensation rate 124 may be displayed alone. In certain other embodiments, the tip bucket icon 122 may be displayed with a defined compensation rate 124. In certain other embodiments, the PMT TERMS 122 and 124 may have different icons or meanings than what are shown in FIG. 1. For example, in certain embodiments the defined compensation rate 124 may be a flat rate rather than an hourly rate.

Once the venue has completed defining the TIME BLOCKS for the days selected, another section may be added with the “Add another Stage Time Block” button 128. The “Add another Stage Time Block” button 128 allows a venue to input additional data specific to a different or overlapping set of available days. The venue may continue using this button 128 until the venue has completed defining the desired days and time blocks it would like to book artists for. The example in FIG. 1 shows a second set of defined available days 126 with only Sunday selected by the venue where the venue may enter additional information as to available times, payment terms, flex, and stage details.

The Define Target Artists section 130 allows the venue to define for each stage category 132, 120, the desired Artist Type 134 for each stage category 120, 132, Genres 136, and a minimum Artist Rating 138. The Artist Rating 138 may be generated from input from other venues who have previously booked the artist. The Artist Rating 138 may also be generated from input from other artists or from third party users of the app that utilize the app to find upcoming events at their favorite venues or for their favorite artists. The data inputted into the Define Target Artists section 130 will be utilized by the system 700 to determine which artists will be able to view the venue's open time slots. In certain other embodiments, further criteria may be used to define target artists for the venue, such as type of entertainment being sought.

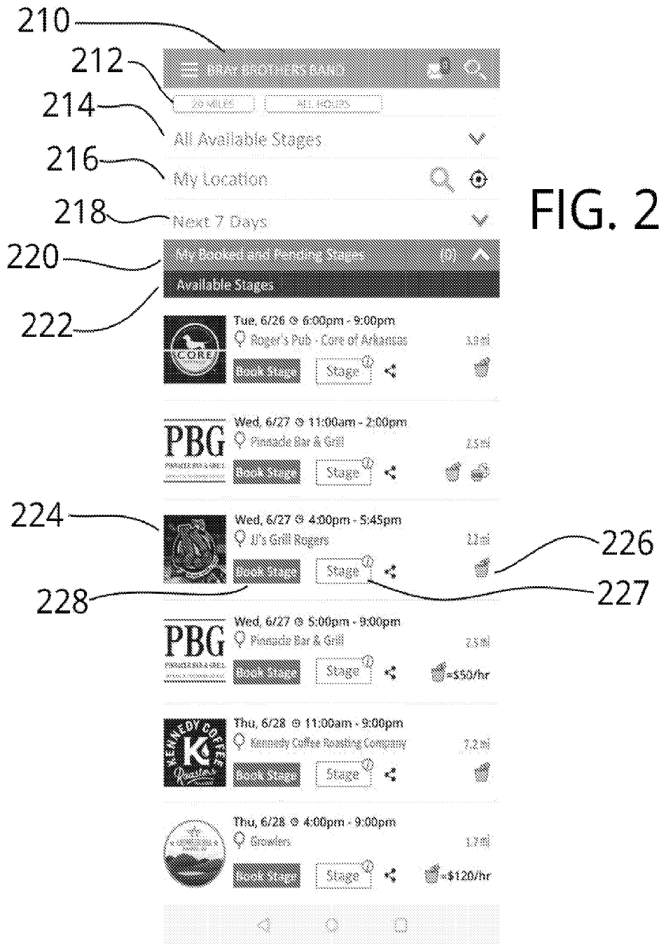

FIG. 2 illustrates an example screenshot of an artist interface where artists may view and select available stages based on certain criteria. The Available Stage Marketplace screen 210 displays stages that are available based on artist-defined distance and time preference criteria 212. In this example, the artist has set a search radius to 20 miles from the center of the artist's preferred location 216, and has designated ALL HOURS to be searched. An ALL HOURS designation means the artist will see available stages for any time of day or night. The artist could also select specific time windows to search. In certain embodiments, an artist may also search by general time categories such as Morning Hours, Lunch Hours, Happy Hours, Night Hours, and Late-Night Hours.

An artist may also define the type of available stages 214 to find in a search; this could be “All Available Stages,” as shown in FIG. 2, or the artist may narrow the search by choosing various ways to filter the available stage selection. The type of available stages 214 could show designations such as all, community favorites, outdoor, indoor, by size, by equipment, most tipped, etc. Artist defines a preferred location 216 to measure the distance preference criteria 212 to locate available stages. This example shows My Location, which is the current GPS location of the artist. However, the artist may input any location in the world. The artist also defines the specific date range 218 to search. This date range 218 may be a specific date or a range of dates. The artist's search criteria listed above is meant to be exemplary of one embodiment of the present invention. However, other search criteria may be defined. For instance, in certain embodiments an artist may also filter search results based upon a venue's ratings or reviews from its own customers or from other artists that have dealt with the venue before.

If the artist has upcoming booked and pending stages they are displayed within the My Booked and Pending Stages section 220. If the artist is a band with an individual that performs outside of the band as well, the booked and pending stages of that individual may be designated to be displayed as well to avoid overlapping bookings. The available stages 222 that match the search criteria 212-218 are listed in separate tile sections. Each venue can display a logo 224 in addition to its name. An artist may learn more about the physical attributes of the available stage by selecting the Stage Information button 227. To learn more about the venue, an artist may select the logo 224 to see the venue's full information profile. The artist may book the venue by selecting the Book Stage button 226. This prompts the interactive database to generate a booking request that will be sent to the venue to alert the venue that the artist wants to book the available stage for the selected time and date. The venue's defined PMT TERMS 122, 124 are also viewable to the artist. If the artist does not meet the venue's pre-defined criteria for target artists 130, then the artist will not be able to view and book the venue under the available stages section.

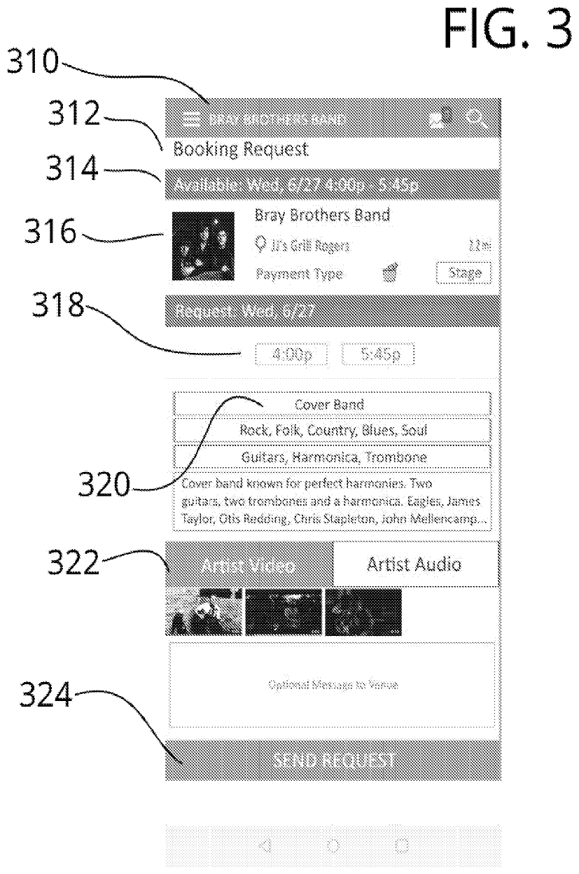

FIG. 3 illustrates an example screenshot of a booking request preview 312 from an artist's perspective. The booking request preview 312 is generated by the interactive database when the “Book Stage” button 228 is selected from FIG. 2 to allow the artist to enter additional data to be sent to the venue. On the booking request preview 312, the stage time block offered by the venue 314. An information confirmation section 316 may also be displayed where an artist can confirm that they're making the booking request for the right artist profile, if the artist has multiple profiles, and confirm the venue, the venue's payment terms, and the distance of the venue from its defined location 216. If the available stage being requested was defined as FLEX 118 by the venue, the artist may designate a preferred time slot 318. Information is pulled from the artist's profile and is included with the Booking Request 320. This can include information about what type of entertainment the artist typically performs or offers. Video and audio files 322 may also be pulled from the artist profile and included to be sent to the venue. The artist may optionally add a comment for the venue. After confirming the correct information in the booking request preview 312, the artist selects the SEND REQUEST button 324 to prompt the system to send the request to the venue.

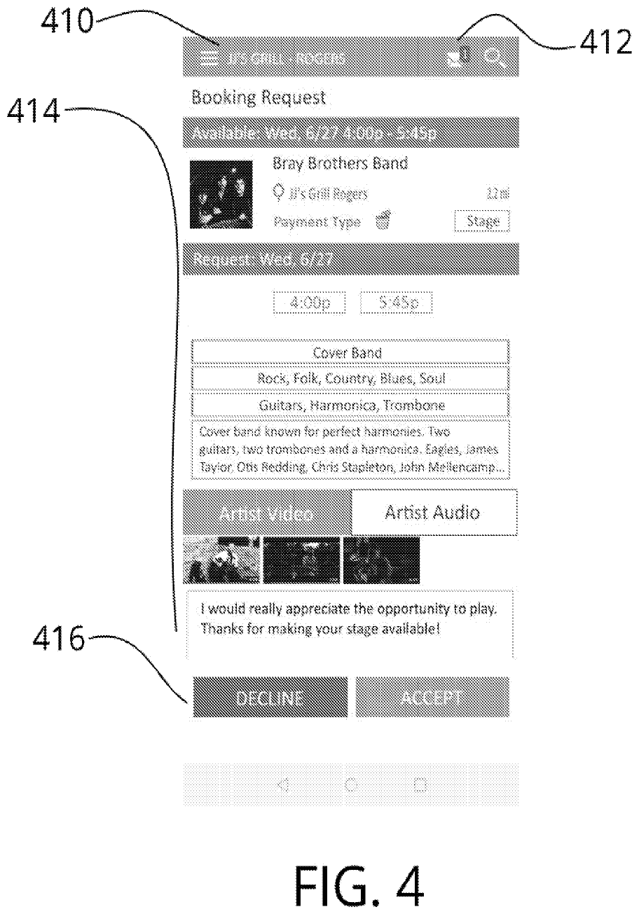

FIG. 4 illustrates an example screenshot of a booking request 410 from a venue's perspective. The interactive database sends the venue a notification 412 alerting it to the booking request 410. The venue may evaluate the artist by viewing and listening to the artist's video and audio samples, and by going directly to the artist's full profile. This notification may be sent via various methods that may include text, email, phone notification through an app, etc. The venue may then select to either DECLINE or ACCEPT 416 the booking request. In certain embodiments, the venue may optionally add a comment for the artist.

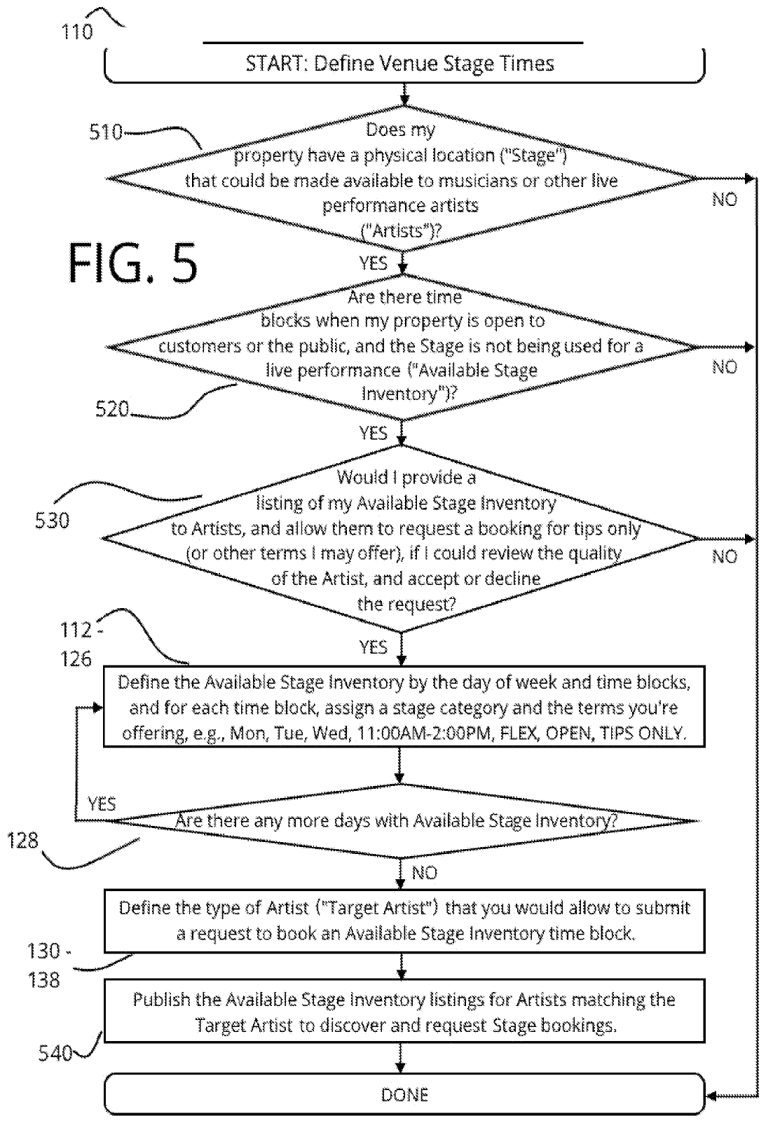

FIG. 5 illustrates a flowchart of example venue data input. The flowchart demonstrates potential pathways and decision trees a venue may make during the Define Stage Times process 110. At step 510, the venue must decide whether there is space for live performances at the venue. At step 520, the venue decides if it can add more days and/or time blocks for live performances. At step 530, the venue decides if they are willing to list their available stages for artists to discover and request bookings, if the venue could evaluate the quality of the artist, and either decline or accept the booking request. If the answer to those three questions is YES, the venue continues to steps 112-126, the process of defining the stage days and time blocks. At step 128, the venue decides if there are more stage days and time blocks to define; if so, the venue continues adding more stage definitions, or if not, the venue moves on to the next step. Step 130-138 defines the Target Artist for each Stage Category. At step 540, the venue is ready to publish or list the Available Stage inventory in the marketplace for Targeted Artists to see and request bookings.

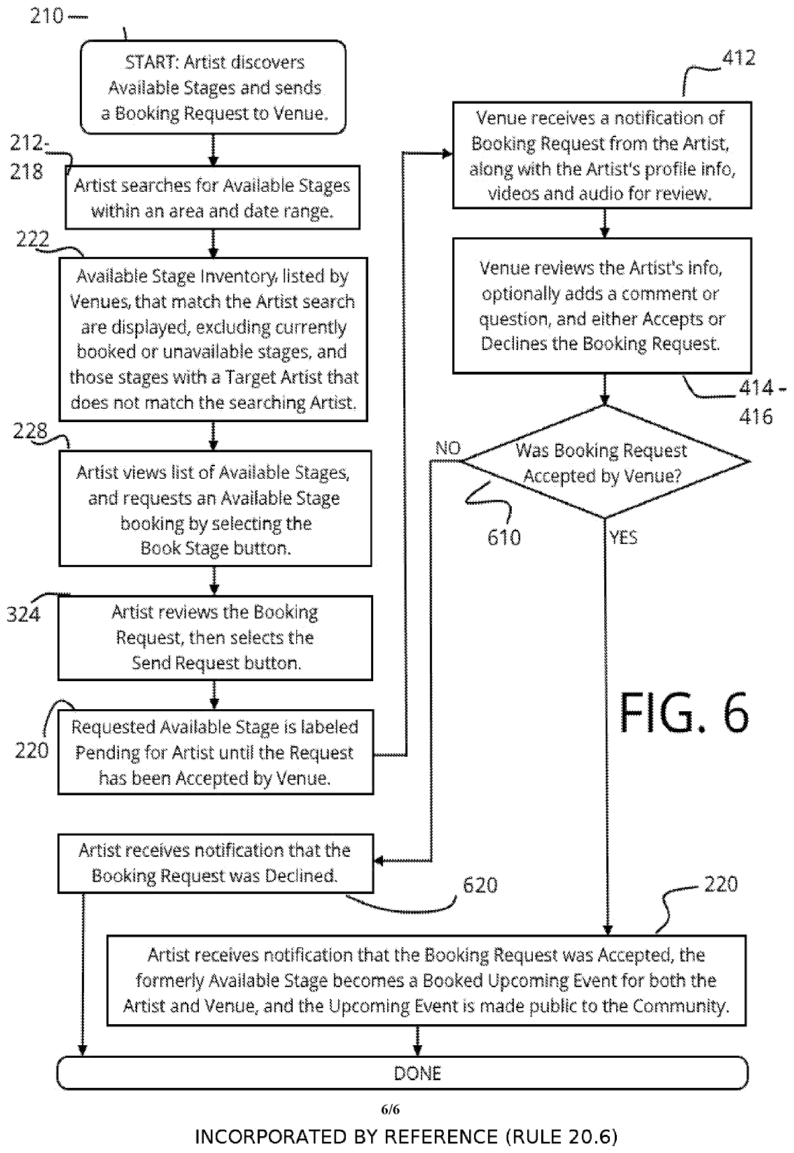

FIG. 6 illustrates a flowchart of example artist data input. FIG. 6 demonstrates the relationship and process between FIG. 2, FIG. 3 and FIG. 4. The artist begins at the start of the process for an artist to both discover available stages and send booking requests to venues 210. At step 212-218, the artist selects the search criteria for available stages within the area radius and date period. At step 222, the Available Stages that have been listed in the marketplace by venues that match the search criteria are listed; this would include all stages from all venues, as defined for each venue using the process of FIG. 1 and FIG. 5, excluding currently booked stages (unavailable stages), and venue stage listings that have a Target Artist definition 130-138 that does not match the artist doing the search.

At step 228, the artist views the search results of available stages and may send booking requests. The artist first reviews the summary information that's visible in each separate tile for each available stage. Further evaluation of the venue may be done by selecting the venue name or picture, which would display the venue's full profile with expanded information. When the artist is ready to request a booking, the “Book Stage” button is selected to open the Booking Request preview. At step 324, the artist reviews a preview of the Booking Request to be sent to the venue, edits the time (if the selected venue has a FLEX stage), optionally adds a comment for the venue, and when ready, selects the SEND REQUEST button. At 220, on the available stage search results for the artist, the “Book Stage” button is removed from the tile of the requested available stage and “Pending” is displayed in its place. The entire tile is moved from the Available Stages section 222 to the Booked and Pending Stage section 220.

At step 412, the venue receives notifications on a graphical user interface, and may select the notification 412 to open and review the Booking Request 410 sent by the artist. The venue may further evaluate the artist by viewing and listening to the artist's video and audio samples 322, or opening the artist's full profile. The venue may also add a comment for the artist. At step 414-416, the venue selects to either Decline or Accept the Booking Request 416.

At step 610, the next process of the system is determined by the venue's response to the Booking Request: If Decline is selected, the process goes to 620; If Accept is selected, the process goes to 220. At 620 when Decline is selected, the artist receives notifications that the Booking Request was declined. The artist may open the declined Booking Request and view any comments sent by the venue. The artist may send another Booking Request for another available stage. At step 222 when Accept is selected, the artist receives notifications that the Booking Request was accepted and the stage requested is changed from Pending to Booked for both the artist and the venue. The booked event is also made public to the Community.

FIG. 7 illustrates a high-level block diagram of the environment and software architecture for the system 700. The system 700 represents the interactive database responsible for processing venue instructions 706 and artist instructions 710. After the venue instructions 706 are processed by the system 700, system feedback 712 is sent to the artist. After artist instructions 710 are processed by the system 700, system feedback 708 is sent to the venue. The system 700 may also communicate with the community 714 once a booking is finalized between the artist and venue by sending a community update 716. A community update 716 may be a notification sent to registered users or it may be a set of instructions the system carries out to publish the event on a website, social media site, or forum. In certain embodiments, the system 700 may publish the community update 716 directly to the venue or artist's designated platforms. A venue may input instructions and view feedback using a venue graphical user interface 702. An artist may input instructions and view feedback from the system using artist graphical user interface 704. While only one venue graphical user interface 702 and artist graphical user interface 706 are shown, there may be multiple graphical user interfaces accessible by the venue or artist. In practice, the system is accessible by multiple users at once.

While various systems and methods have been described above in connection with several illustrative embodiments, it is to be understood that other similar embodiments may be used or modified, and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. The scope of the present disclosure is determined by the claims that follow.

1. A non-transitory computer readable medium having stored software instructions that, when executed by a processor, cause the processor to automatically create, maintain, and access an interactive database for booking stages, by executing the steps comprising:
receiving venue data input from a venue;
storing the venue data input in a non-transitory computer storage medium;
causing venue data input to be viewable to target artists designated by the venue through a graphical user interface;
receiving artist data input from an artist;
storing the artist data input in a non-transitory computer storage medium; generating a booking request from the artist data input; and,
causing the booking request to be viewable and actionable to the venue through a graphical user interface.

2. The method of claim 1, further comprising creating a booking response when the venue submits an acceptance of the booking request, the booking response stimulating the processor the execute the steps comprising:
alerting the artist to the acceptance;
removing the first set of data input from the graphical user interface of the target artists.

3. The method of claim 2, further comprising publishing notice of the event to a community.

4. The method of claim 1, wherein the venue data input is information concerning available stages and time slots at the venue.

5. The method of claim 1, wherein the artist data input is a selection of a stage at an available time slot.

6. The method of claim 1, wherein the target artists are of a group of artists that meet criteria defined by the venue.

7. The method of claim 1, wherein the booking request includes recordings of the target artist capable of being transmitted to and viewed by the venue.

8. A computer implemented system for facilitating artist access to a set of available venues and time slots, the system comprising:
an interactive database that adapts and automatically adjusts to input from a plurality of users, the interactive database comprising memory capable of storing a plurality of instructions and at least one processor cooperatively connected to the memory and capable of executing the plurality of instructions; and,
at least one device capable of displaying a graphical user interface and receiving a plurality of instructions.

9. The system of claim 8, wherein the plurality of users comprise at least one venue and at least one artist.

10. The system of claim 8, wherein the plurality of users comprise at least one venue, at least one artist, and a community.

11. The system of claim 8, wherein the plurality of instructions comprises: venue data input conveying available stages and time slots; and,
artist data input conveying an artist's interest in booking an available stage and time slot.

12. The system of claim 11, wherein the plurality of instructions further comprises a response to a booking request.
